(19) United States
(12) Patent Application Publication
(10) Pub. No.: US 2019/0152291 A1
(43) Pub. Date: May 23, 2019

(54) INSIDE/OUTSIDE AIR SWITCHING DEVICE

(71) Applicant: DENSO CORPORATION, Kariya-city (JP)

(72) Inventor: Keizo GOTO, Kariya-city (JP)

(21) Appl. No.: 16/251,207

(22) Filed: Jan. 18, 2019

Related U.S. Application Data
(63) Continuation of application No. PCT/JP2017/006901, filed on Feb. 23, 2017.

(30) Foreign Application Priority Data
Jul. 22, 2016 (JP) 2016-144483

(51) Int. Cl. B60H 1/00; F16H 21/40

(52) U.S. Cl. CPC B60H 1/00857; B60H 1/00671; F16H 21/40

(57) ABSTRACT

When the output shaft rotates by 180° from a reference angle in a forward direction, the link mechanism moves the inside-outside air door from one position to the other one position of an outside air blocking position and an inside air blocking position. When the output shaft further rotates by 180° in the forward direction from a rotation angle of the output shaft, which has rotated by 180° from the reference angle in the forward direction, the link mechanism moves the inside-outside air door from the other one position to the one position. When moving the inside-outside air door between the one position and the other one position, the actuator rotates the output shaft in an operation range between the reference angle and the rotation angle of the output shaft rotated by 180° from the reference angle in the forward direction in accordance with a detection value of the potentiometer.

### CROSS REFERENCE TO RELATED APPLICATIONS

The present application is a continuation application of International Patent Application No. PCT/JP2017/006901 filed on Feb. 23, 2017, which designated the United States and claims the benefit of priority from Japanese Patent Application No. 2016-144483 filed on Jul. 22, 2016. The entire disclosures of all of the above applications are incorporated herein by reference.

### TECHNICAL FIELD

The present disclosure relates to an inside/outside air switching device that adjusts introduction amounts of an inside air and an outside air.

### BACKGROUND ART

Up to now, a vehicle air conditioner is equipped with an inside-outside air switch device for selectively opening and closing an inside air introduction port for introducing an interior air and an outside air introduction port for introducing an exterior air by an inside-outside air door.

### SUMMARY

According to the present disclosure, there is provided an inside/outside air switching device for adjusting introduction amounts of inside air and outside air, including an inside-outside air case that includes an inside air introduction port through which to introduce inside air and an outside air introduction port through which to introduce outside air, an inside-outside air door configured to open or close the inside air introduction port and the outside air introduction port, an actuator that includes a servomotor having an output shaft configured to output driving force for rotationally driving the inside-outside air door, and a link mechanism configured to transmit the driving force outputted by the output shaft to the inside-outside air door. When the output shaft rotates by 180 degrees from a predetermined reference angle in a forward direction, the link mechanism is configured to move the inside-outside air door from one position of an outside air blocking position to close the outside air introduction port and an inside air blocking position to close the inside air introduction port to the other one position of the outside air blocking position and the inside air blocking position. When the output shaft further rotates by 180 degrees in the forward direction from a rotation angle of the output shaft, which has rotated by 180 degrees from the reference angle in the forward direction, the link mechanism is configured to move the inside-outside air door from the other one position to the one position. The actuator includes a potentiometer configured to detect a rotation angle of the output shaft. When moving the inside-outside air door between the one position and the other one position, the actuator is configured to rotate the output shaft in an operation range between the reference angle and the rotation angle of the output shaft rotated by 180 degrees from the reference angle in the forward direction in accordance with a detection value of the potentiometer.

### BRIEF DESCRIPTION OF DRAWINGS

FIG. 1 is a schematic cross-sectional view of an inside-outside air switch device according to an embodiment;

FIG. 2 is a schematic external view of an inside-outside air switch device according to the embodiment;

FIG. 3 is a schematic configuration diagram of a link mechanism of the inside-outside air switch device according to the embodiment;

FIG. 4 is a schematic configuration diagram of an intermediate link member of the link mechanism according to the embodiment;

FIG. 5 is a schematic configuration diagram of a drive circuit of the inside-outside air switch device according to the embodiment;

FIG. 6 is a characteristic diagram showing a relationship between a drive position of the inside-outside air door and a rotation angle of an output shaft;

FIG. 7 is a schematic diagram showing operation states of the link mechanism and the inside-outside air door when the output shaft has a reference angle;

FIG. 8 is a schematic view showing the operation states of the link mechanism and the inside-outside air door when the output shaft is rotated by 180° in a forward direction from the reference angle;

FIG. 9 is a schematic view showing the operation states of the link mechanism and the inside-outside air door when the output shaft is rotated by 90° in the forward direction from the reference angle; and

FIG. 10 is a schematic view showing the operation states of the link mechanism and the inside-outside air door when the output shaft is rotated by 270° in the forward direction from the reference angle.

### DETAILED DESCRIPTION

An inside-outside air switch device of an example is configured to selectively open and close the inside air introduction port and the outside air introduction port by transmitting a driving force from a driving source such as a servomotor to the inside-outside air door through a link mechanism.

It is conceivable that a link mechanism of an inside-outside air switch device is configured to move the inside-outside air door to a close position of the inside air introduction port when an output shaft rotates by 180° in a forward direction from the predetermined reference angle. The link mechanism is configured to move the inside-outside air door to the close position of the outside air introduction port when the output shaft further rotates by 180° in the forward direction from a rotation angle of the output shaft rotated by 180° in the forward direction with respect to a reference angle.

Incidentally, in the vehicle air conditioner, if only the interior air is introduced, the air conditioning efficiency can be improved by the circulation of the inside air, but window fogging is apt to occur due to an increase in humidity due to respiration of an occupant or the like. In addition, in the vehicle air conditioner, although it is possible to reduce the window fogging when only the outside air is introduced, the air conditioning efficiency is lowered as compared with a case in which only the inside air is introduced. For that reason, in the vehicle air conditioner, both of the outside air and inside air are introduced, so that the air conditioning efficiency can be improved and the window fogging can be reduced.

However, in the above inside-outside air switch device, the link mechanism is configured such that one of the inside air introduction port and the outside air introduction port is closed when the output shaft of the servomotor is rotated by 180°, and both of the outside air and the inside air cannot be introduced.

On the other hand, although it is conceivable to change the link mechanism so that the inside-outside air door also stops at a position where both of the inside air introduction port and the outside air introduction port are opened, there is a concern that the link mechanism has a complicated configuration.

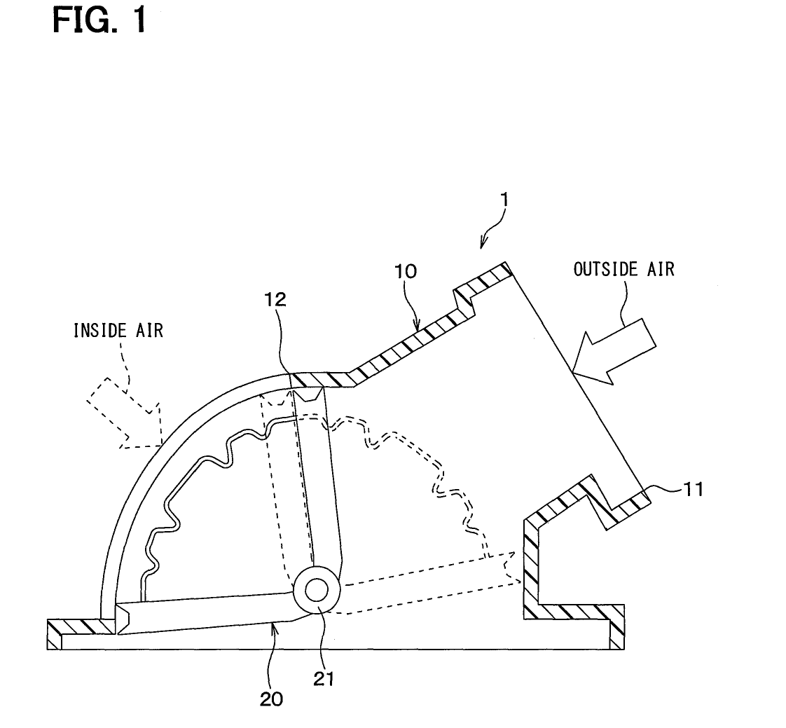

One embodiment of the present disclosure will be described with reference to FIGS. 1 to 10. An inside/outside air switching device 1 is a device for adjusting the introduction amounts of an interior air (hereinafter, also referred to as inside air) and an exterior air (hereinafter, also referred to as outside air) to be introduced into a vehicle air conditioner.

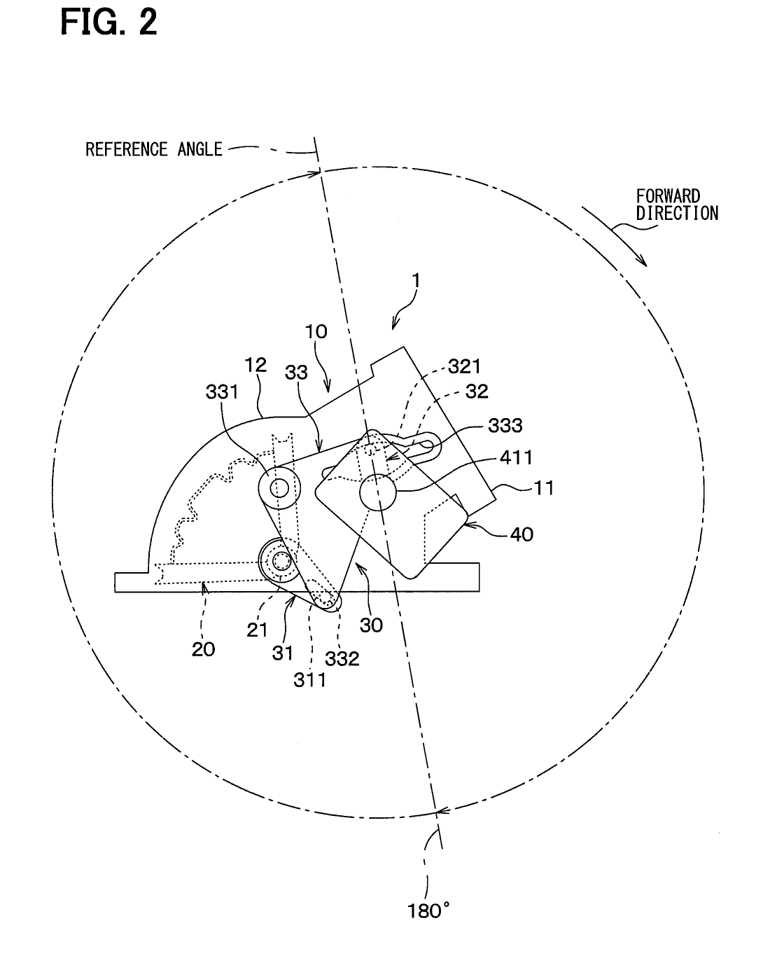

As shown in FIGS. 1 and 2, the inside/outside air switching device 1 includes, as main components, an inside-outside air case 10, an inside-outside air door 20, a link mechanism 30, and an actuator 40, which configure an outer shell.

The inside-outside air case 10 is a member configuring an outer shell of the inside/outside air switching device 1. Although not shown, the inside-outside air case 10 is connected to an air conditioning case of an air conditioning unit in which a blower, a cooling heat exchanger, a heating heat exchanger, and the like are accommodated.

An outside air introduction port 11 for introducing the outside air and an inside air introduction port 12 for introducing the inside air are provided in the inside-outside air case 10. The outside air introduction port 11 is connected to an outside air suction port not shown provided in a vehicle body. The inside-outside air cases 10 are made of a resin (for example, polypropylene) having a certain degree of elasticity and an excellent strength.

The inside-outside air door 20 is an opening and closing member for opening and closing the outside air introduction port 11 and the inside air introduction port 12 provided in the inside-outside air case 10. The inside-outside air door 20 is accommodated between the outside air introduction port 11 and the inside air introduction port 12 in the inside-outside air case 10. The inside-outside air door 20 has a rotation shaft 21 rotatably supported by the inside-outside air cases 10.

In FIG. 1, a state in which the inside-outside air door 20 has moved to an inside air blocking position for closing the inside air introduction port 12 is indicated by a solid line, and a state in which the inside-outside air door 20 has moved to an outside air blocking position for closing the outside air introduction port 11 is indicated by a broken line.

The inside-outside air door 20 according to the present embodiment is configured by a rotary door having an arcuate outer peripheral wall portion and a fan-shaped side plate connected to an end portion of the outer peripheral wall. The inside-outside air door 20 is not limited to the rotary door, and may be configured by a cantilever plate door.

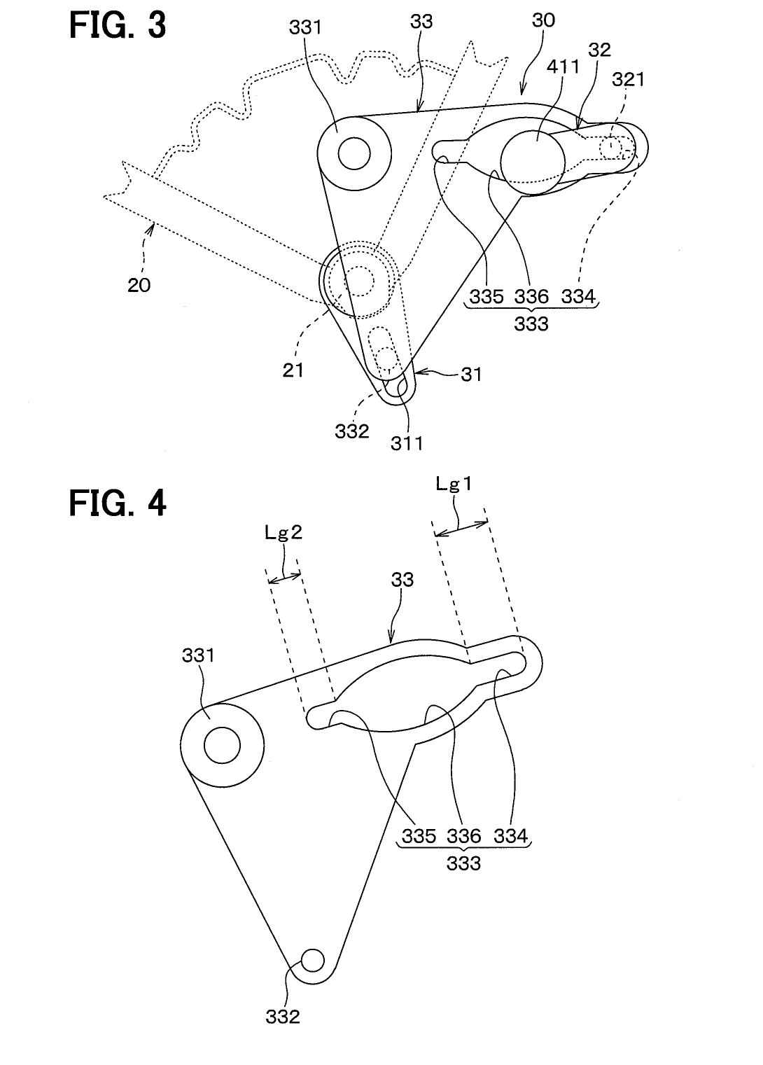

The link mechanism 30 shown in FIGS. 2 and 3 is a member for transmitting a driving force output from an output shaft 411 of a servomotor 41, which will be described later, to the inside-outside air door 20. As shown in FIG. 2, the link mechanism 30 is attached to the inside-outside air cases 10.

The link mechanism 30 according to the present embodiment is configured to be able to move the inside-outside air door 20 from the inside air blocking position to the outside air blocking position when the output shaft 411 is rotated by 180° in the forward direction from a predetermined reference angle. In addition, the link mechanism 30 according to the present embodiment is configured so that when the output shaft 411 rotates by 180° in a positive direction from the rotation angle of 180° in a forward direction with respect to the reference angle, the inside-outside air door 20 can be moved from the outside air blocking position to the inside air blocking position. In the present embodiment, a clockwise direction, that is, a right turning direction is defined as the forward direction. Further, in the present embodiment, the rotation angle of the output shaft 411 in a state where the inside-outside air door 20 has moved to the inside air blocking position is set as a reference angle.

In this example, in the link mechanism 30 employed in the present embodiment, a manual air conditioning link mechanism and an automatic air conditioning link mechanism are configured by a sharable link mechanism. The manual air conditioning is an air conditioning system for controlling the inside/outside air switching device 1 by a user's switch operation or the like. The automatic air conditioning is an air conditioning system in which a control device not shown automatically controls the inside/outside air switching device 1 based on an outside air temperature, an inside air temperature, and the like, without relying on the user's switch operation or the like.

As shown in FIG. 3, the link mechanism 30 according to the present embodiment includes a door side lever 31, a motor side lever 32, and an intermediate link member 33. First, the door side lever 31 will be described. The door side lever 31 is formed of an oval-shaped plate-like member. The door side lever 31 is connected to the rotation shaft 21 of the inside-outside air door 20 at one end side so as to rotate about the rotation shaft 21 integrally with the inside-outside air door 20. In the present embodiment, the rotation shaft 21 configures a driven side support shaft for rotatably supporting the door side lever 31.

The door side lever 31 has a driven side guide groove 311 along which an intermediate pin 332 slides, which will be described later, at a portion of the door side lever 31 on the other end side. The driven side guide groove 311 is configured by a groove linearly extending toward the rotation shaft 21 so that both of the door side lever 31 and the inside-outside air door 20 rotate about the rotation shaft 21 when the intermediate pin 332 to be described later moves.

Subsequently, the motor side lever 32 is formed of a plate-like member having an oval shape. The motor side lever 32 is connected to the output shaft 411 of the servomotor 41 at one end side so as to rotate about the output shaft 411 integrally with the output shaft 411 of the servomotor 41.

The motor side lever 32 is provided with a drive pin 321 on the other end side. The drive pin 321 is a member for connecting the motor side lever 32 to the intermediate link member 33. The drive pin 321 slides in an intermediate guide groove 333 provided in the intermediate link member 33 when the output shaft 411 of the servomotor 41 rotates.

Subsequently, the intermediate link member 33 is formed of a plate-like member having a substantially triangular shape. The intermediate link member 33 is connected to an intermediate support shaft 331 that rotatably supports the intermediate link member 33 at one of three corners. The intermediate support shaft 331 is integrally formed with the inside-outside air case 10.

In the intermediate link member 33, an intermediate pin 332 is provided at one of the three corners to which the intermediate support shaft 331 is not connected, and an intermediate guide groove 333 having a predetermined shape is provided at another corner.

The intermediate pin 332 connects the intermediate link member 33 to the door side lever 31. The intermediate pin 332 slides in the driven side guide groove 311 of the door side lever 31 when the intermediate link member 33 rotates. The intermediate guide groove 333 is a groove in which the drive pin 321 slides when the output shaft 411 of the servomotor 41 rotates. As shown in FIG. 4, the intermediate guide groove 333 according to the present embodiment includes a first transmission groove portion 334, a second transmission groove portion 335, and an annular groove portion 336.

The first transmission groove portion 334 is a groove that transmits the movement of the drive pin 321 to the door side lever 31 when the output shaft 411 is rotated by 180 in the forward direction from the reference angle, and moves the inside-outside air door 20 from the inside air blocking position to the outside air blocking position.

The second transmission groove portion 335 is a groove that transmits the movement of the drive pin 321 to the door side lever 31 and moves the inside-outside air door 20 from the outside air blocking position to the inside air blocking position when the output shaft 411 rotates by 180° relative to the reference angle by 180° in a more forward direction.

The annular groove portion 336 is a groove portion that connects the first transmission groove portion 334 and the second transmission groove portion 335. The annular groove portion 336 is provided to absorb variations in the stop position of the inside-outside air door 20 caused by variations in the driving force output from the output shaft 411.

The annular groove portion 336 according to the present embodiment is configured by a groove portion formed in an oval shape. Specifically, the annular groove portion 336 according to the present embodiment is configured by a groove portion formed in an oval shape so that the intermediate support shaft 331 is positioned on an extension line of a long axis. The annular groove portion 336 according to the present embodiment has a pair of arcuate idle groove portions which draw a movement locus of the drive pin 321 when the output shaft 411 rotates.

The first transmission groove portion 334 according to the present embodiment is configured by a groove extending linearly from the annular groove portion 336 toward an opposite side to the intermediate support shaft 331. The first transmission groove portion 334 according to the present embodiment linearly extends along the direction in which the long axis of the annular groove portion 336 extends.

The second transmission groove portion 335 according to the present embodiment is configured by a groove linearly extending from the annular groove portion 336 toward the intermediate support shaft 331. Similar to the first transmission groove portion 334, the second transmission groove portion 335 according to the present embodiment linearly extends along the direction in which the long axis of the annular groove portion 336 extends.

The first transmission groove portion 334 according to the present embodiment is formed at a position farther from the intermediate support shaft 331 than the second transmission groove portion 335. In the first transmission groove portion 334 according to the present embodiment, a groove length Lg1 in which the drive pin 321 slides is longer than a groove length Lg2 in which the drive pin 321 slides in the second transmission groove portion 335.

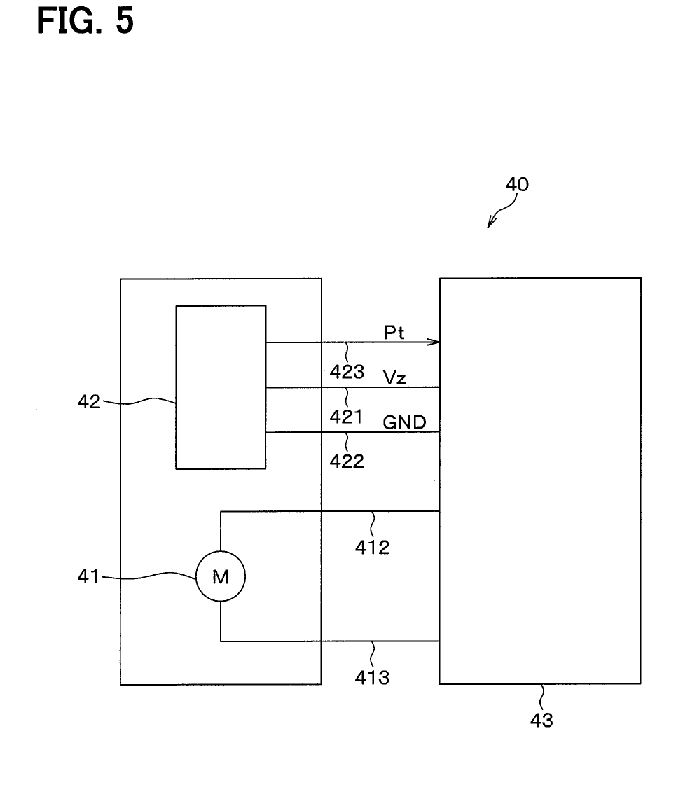

Subsequently, the actuator 40 is a member for driving the inside-outside air door 20 through the link mechanism 30. As shown in FIG. 2, the actuator 40 is attached to the inside-outside air case 10 together with the link mechanism 30. As shown in FIG. 5, the actuator 40 according to the present embodiment includes a servomotor 41, a potentiometer 42, a speed reduction mechanism (not shown), and a drive circuit 43.

The servomotor 41 outputs a driving force by energization. The servomotor 41 has the output shaft 411 shown in FIGS. 2 and 3. The output shaft 411 is a member for outputting the driving force for rotationally driving the inside-outside air door 20, and is connected to the motor side lever 32, as shown in FIG. 2.

As shown in FIG. 5, the servomotor 41 is connected to the drive circuit 43 through two connection terminals 412 and 413. The servomotor 41 according to the present embodiment is configured to be able to rotate the output shaft 411 not only in the forward direction but also in a direction opposite to the forward direction.

The potentiometer 42 detects the rotation angle of the output shaft 411 of the servomotor 41. The potentiometer 42 has a printed board on which a resistance pattern (not shown) is formed. The potentiometer 42 according to the present embodiment employs an inexpensive potentiometer in which a single-layer resistance pattern is formed, and is capable of detecting a rotation angle in a range from 0° to less than 360° (for example, 340°).

The potentiometer 42 is connected to the drive circuit 43 through three brushes 421 to 423. The potentiometer 42 has a brush 421 for applying an input voltage Vz from the drive circuit 43 to the resistance pattern, a brush 422 for connecting the resistance pattern to GND, and a brush 423 for outputting a potentiometer voltage Pt corresponding to the rotation angle of the output shaft 411 to the drive circuit 43.

The drive circuit 43 is a circuit for driving the servomotor 41. The drive circuit 43 controls the rotation angle of the output shaft 411 of the servomotor 41 based on a detection value of the potentiometer 42. The drive circuit 43 includes a microcomputer, an A/D conversion circuit, a storage unit, and the like (not shown). The storage unit of the drive circuit 43 is configured by a non-transitory tangible storage medium.

Incidentally, in the vehicle air conditioner, if only the interior air is introduced, the air conditioning efficiency can be improved by the circulation of the inside air, but window fogging is apt to occur due to an increase in humidity due to respiration of an occupant or the like. In addition, in the vehicle air conditioner, although it is possible to reduce the window fogging when only the outside air is introduced, the air conditioning efficiency is lowered as compared with a case in which only the inside air is introduced. For that reason, with the introduction of both of the outside air and the inside air, the air conditioning efficiency can be improved and the window fogging can be reduced.

However, in the conventional inside/outside air switching device, the link mechanism is configured so that one of the inside air introduction port and the outside air introduction port is closed when the output shaft of the servomotor is rotated by 180°, and both of the outside air and the inside air cannot be introduced.

On the other hand, although it is conceivable to change the link mechanism so that the inside-outside air door stops even at a position where both of the inside air introduction port and the outside air introduction port are opened, there is a concern that the link mechanism has a complicated configuration. In addition, when the link mechanism is changed, there is a need to change other components such as the inside-outside air case.

Therefore, the inside/outside air switching device 1 according to the present embodiment is configured to stop the inside-outside air door 20 at a position where both of the inside air introduction port 12 and the outside air introduction port 11 are opened by the actuator 40 without changing the link mechanism 30.

The actuator 40 according to the present embodiment is configured to rotate the output shaft 411 in an operation range from a reference angle to a rotation angle rotated by 180° in the forward direction in accordance with the detection value of the potentiometer 42 when the inside-outside air door 20 is moved between the outside air blocking position and the inside air blocking position.

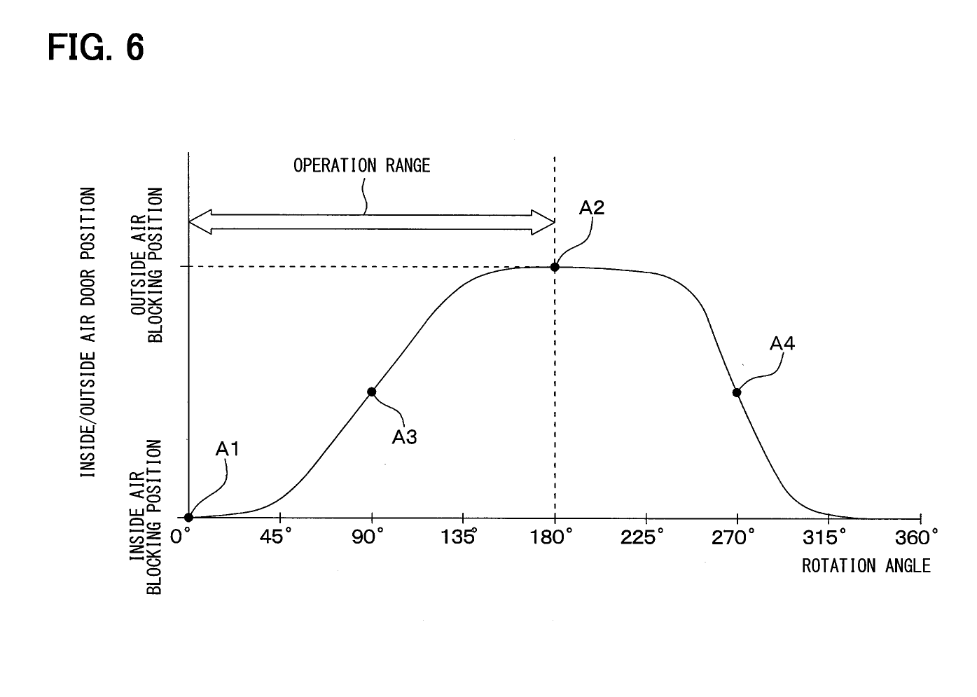

Specifically, as shown in FIG. 6, the actuator 40 according to the present embodiment rotates the output shaft 411 in the operation range from the reference angle to the rotation angle rotated by 180° in the forward direction, thereby moving the inside-outside air door 20 between the outside air blocking position and the inside air blocking position.

Further, the actuator 40 according to the present embodiment stops the output shaft 411 at a rotation angle larger than the reference angle and smaller than 180° in the forward direction with respect to the reference angle, thereby stopping the inside-outside air door 20 at a position at which both of the inside air introduction port 12 and the outside air introduction port 11 are opened.

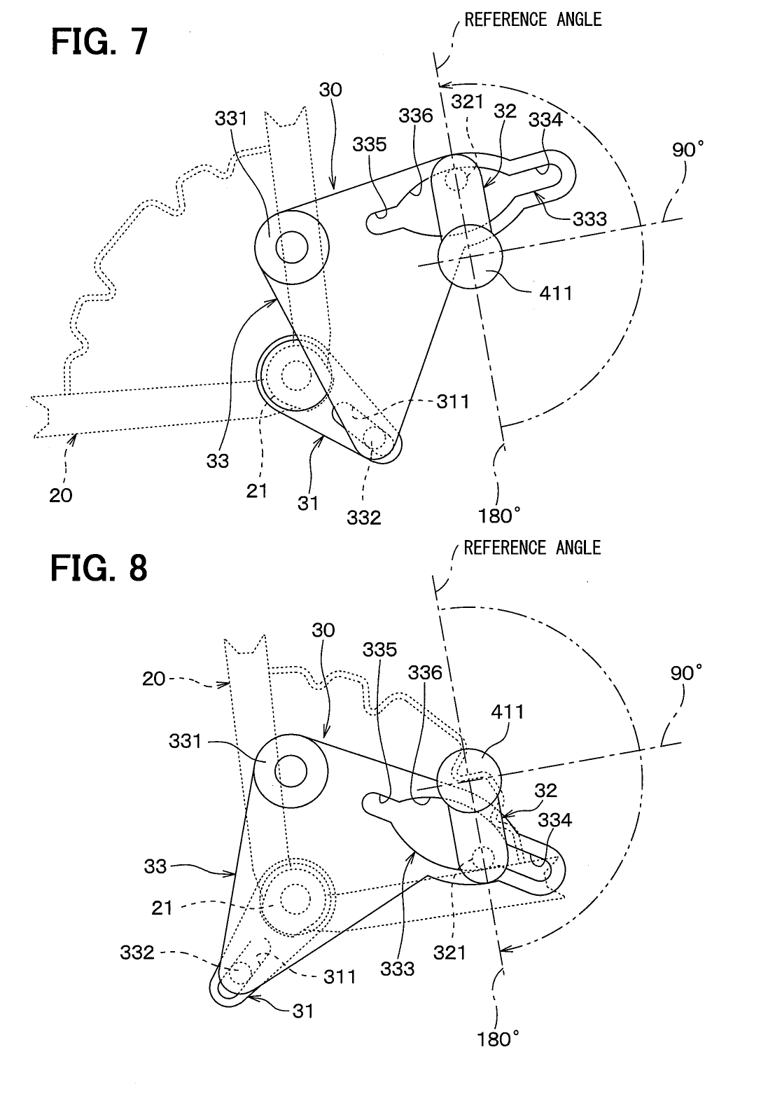

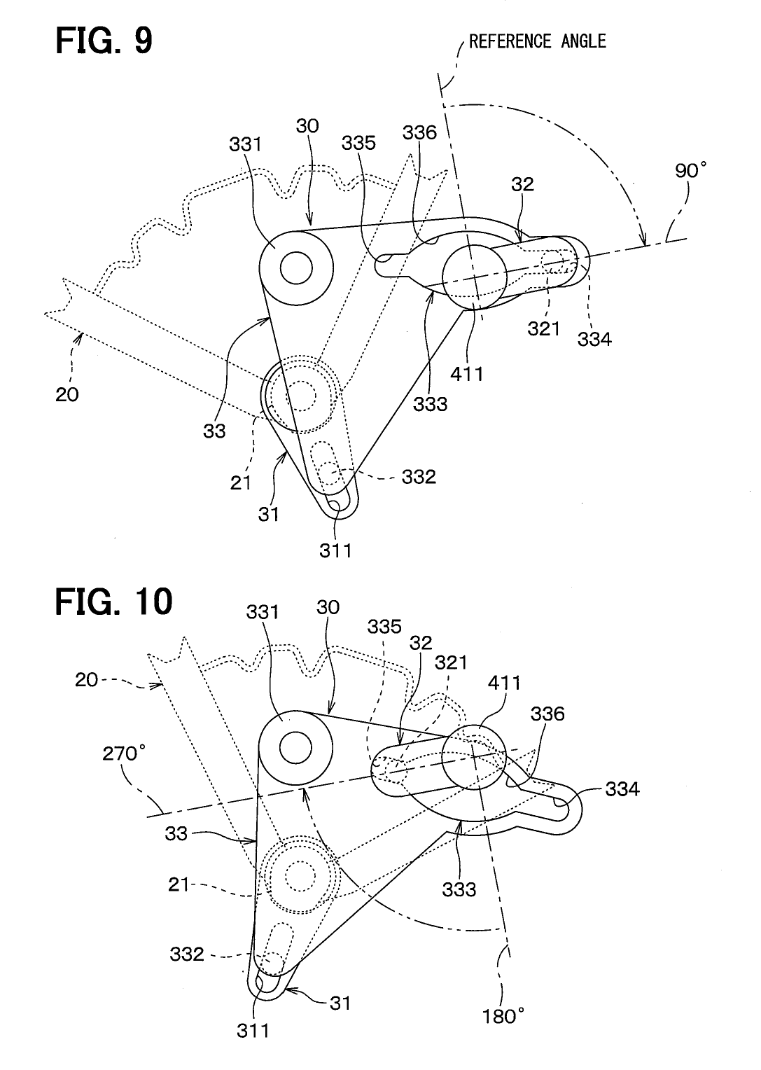

Next, the operation of the inside/outside air switching device 1 according to the present embodiment will be described with reference to FIGS. 7 to 10. FIG. 7 is a schematic view showing the operation states of the link mechanism 30 and the inside-outside air door 20 when the output shaft 411 is at the reference angle, as indicated by a point A1 in FIG. 6. FIG. 8 is a schematic view showing the operation states of the link mechanism 30 and the inside-outside air door 20 when the output shaft 411 is rotated by 180° in the forward direction from the reference angle as indicated by a point A2 in FIG. 6. FIG. 9 is a schematic view showing the operation states of the link mechanism 30 and the inside-outside air door 20 when the output shaft 411 is rotated by 90° in the forward direction from the reference angle as indicated by a point A3 in FIG. 6. FIG. 10 is a schematic view showing the operation states of the link mechanism 30 and the inside-outside air door 20 when the output shaft 411 is rotated 270° in the forward direction from the reference angle as indicated by a point A4 in FIG. 6.

In the inside/outside air switching device 1 according to the present embodiment, when switching from an inside air mode in which the inside air is introduced to an outside air mode in which the outside air is introduced, the actuator 40 rotates the output shaft 411 of the servomotor 41 in a reverse direction so that the rotation angle becomes 180° to 0° (that is, the reference angle).

As a result, the link mechanism 30 and the inside-outside air door 20 transition from a state shown in FIG. 8 to a state shown in FIG. 7. Specifically, when the output shaft 411 rotates by 180° in the opposite direction from the rotation angle shown in FIG. 8, the drive pin 321 of the motor side lever 32 slides in the first transmission groove portion 334 of the intermediate link member 33 and moves to a position shown in FIG. 7. In this situation, the intermediate pin 332 of the intermediate link member 33 slides in the driven side guide groove 311 of the door side lever 31, with the result that the door side lever 31 rotates about the rotation shaft 21. As a result, the inside-outside air door 20 moves from the outside air blocking position to the inside air blocking position.

In addition, in the inside/outside air switching device 1 according to the present embodiment, when switching from the outside air mode in which outside air is introduced to the inside air mode in which inside air is introduced, the actuator 40 rotates the output shaft 411 of the servomotor 41 in the forward direction so that the rotation angle becomes 180° from the reference angle.

As a result, the link mechanism 30 and the inside-outside air door 20 transition from a state shown in FIG. 7 to a state shown in FIG. 8. Specifically, when the output shaft 411 rotates by 180° in the forward direction from the rotation angle shown in FIG. 7, the drive pin 321 of the motor side lever 32 slides in the first transmission groove portion 334 of the intermediate link member 33 and moves to the position shown in FIG. 8. In this situation, the intermediate pin 332 of the intermediate link member 33 slides in the driven side guide groove 311 of the door side lever 31, with the result that the door side lever 31 rotates about the rotation shaft 21. As a result, the inside-outside air door 20 moves from the inside air blocking position to the outside air blocking position.

In addition, in the inside/outside air switching device 1 according to the present embodiment, when switching from the outside air mode in which the outside air is introduced to an inside/outside air mode in which both of the outside air and the inside air are introduced, the actuator 40 rotates the output shaft 411 of the servomotor 41 in the forward direction so that the rotation angle becomes 90° from the reference angle.

As a result, the link mechanism 30 and the inside-outside air door 20 transition from the state shown in FIG. 7 to the state shown in FIG. 9. More specifically, when the output shaft 411 rotates 90 degrees in the forward direction from the rotation angle shown in FIG. 7, the drive pin 321 of the motor side lever 32 slides in the first transmission groove portion 334 of the intermediate link member 33 and moves to a position shown in FIG. 9. In this situation, the intermediate pin 332 of the intermediate link member 33 slides in the driven side guide groove 311 of the door side lever 31, with the result that the door side lever 31 rotates about the rotation shaft 21. As a result, the inside-outside air door 20 moves from the inside air blocking position to a position in which both of the inside air introduction port 12 and the outside air introduction port 11 are opened.

In the inside/outside air switching device 1 according to the present embodiment, when switching from the inside air mode to the inside/outside air mode, the actuator 40 reversely rotates the output shaft 411 of the servomotor 41 so that the rotation angle becomes from 180° to 90°.

By the way, switching from the outside air mode or the inside air mode to the inside/outside air mode can be realized by rotating the output shaft 411 of the servomotor 41 until the rotation angle becomes 270°, as shown in FIG. 10.

When the output shaft 411 of the servomotor 41 is rotated until the rotation angle becomes 270°, the drive pin 321 of the motor side lever 32 slides in the second transmission groove portion 335 of the intermediate link member 33 and moves to a position shown in FIG. 10. In this situation, the intermediate pin 332 of the intermediate link member 33 slides in the driven side guide groove 311 of the door side lever 31, with the result that the door side lever 31 rotates about the rotation shaft 21. As a result, the inside-outside air door 20 moves to a position where both of the inside air introduction port 12 and the outside air introduction port 11 are opened.

In this example, the link mechanism 30 is configured such that the drive pin 321 moves in the first transmission groove portion 334 when the output shaft 411 rotates in a range of 0° to 180°, and the drive pin 321 moves in the second transmission groove portion 335 when the output shaft 411 rotates in a range of 180° to 360°.

In the link mechanism 30 according to the present embodiment, the first transmission groove portion 334 of the intermediate link member 33 is provided at a position farther from the intermediate support shaft 331 than the second transmission groove portion 335. In other words, in the intermediate link member 33 according to the present embodiment, the second transmission groove portion 335 is provided at a position closer to the intermediate support shaft 331 than the first transmission groove portion 334.

For that reason, in the link mechanism 30 according to the present embodiment, when the output shaft 411 rotates in the range of 0° to 180°, the amount of movement of the inside-outside air door 20 with respect to the rotation angle of the output shaft 411 becomes smaller than the amount of movement when the output shaft 411 rotates in the range of 180° to 360°. That is, in the link mechanism 30 according to the present embodiment, when the drive pin 321 moves in the first transmission groove portion 334, the amount of movement of the inside-outside air door 20 relative to the rotation angle of the output shaft 411 is smaller than the amount of movement when the drive pin 321 moves in the second transmission groove portion 335. In other words, in the link mechanism 30, when the output shaft 411 rotates in the range of 0° to 180°, the amount of movement of the inside-outside air door 20 per unit rotation angle of the output shaft 411 is smaller than the amount of movement when the output shaft 411 rotates in the range of 180° to 360°.

The small amount of movement of the inside-outside air door 20 relative to the rotation angle of the output shaft 411 has an advantage that the stop position of the inside-outside air door 20 can be finely set. In consideration of the above advantage, the inside/outside air switching device 1 according to the present embodiment is configured to rotate the output shaft 411 in an operation range from the reference angle to the rotation angle rotated by 180° in the forward direction when the inside-outside air door 20 is moved between the outside air blocking position and the inside air blocking position.

The inside/outside air switching device 1 according to the present embodiment described above has a configuration in which the actuator 40 rotates the output shaft 411 of the servomotor 41 in an operation range between the reference angle and the rotation angle rotated by 180° in the forward direction from the reference angle in accordance with the detection value of the potentiometer 42. This makes it possible to stop the inside-outside air door 20 at a position where both of the inside air introduction port 12 and the outside air introduction port 11 are opened without changing the shape or the like of the link mechanism 30.

As shown in FIG. 6, the link mechanism 30 according to the present embodiment is configured to be able to move the inside-outside air door 20 from the inside air blocking position to the outside air blocking position when the output shaft 411 is rotated by 180° in the forward direction from the reference angle. In addition, the link mechanism 30 according to the present embodiment is configured so that when the output shaft 411 rotates by 180° in a positive direction from the rotation angle of 180° in a forward direction with respect to the reference angle, the inside-outside air door 20 can be moved from the outside air blocking position to the inside air blocking position.

The link mechanism 30 configured as described above can function as a device for manual air conditioning which selectively opens and closes the inside air introduction port 12 and the outside air introduction port 11 by applying an actuator that rotates only in the forward direction, instead of the actuator 40 according to the present embodiment. In other words, the link mechanism 30 according to the present embodiment can be shared by the device for manual air conditioning and a device for automatic air conditioning. Such shared use of the components greatly contributes to a reduction in management man-hours of the components and a reduction in procurement costs, design costs, and the like of the components.

The inside/outside air switching device 1 according to the present embodiment is configured to rotate the output shaft 411 so that the drive pin 321 moves in the first transmission groove portion 334 away from the intermediate support shaft 331 when the inside-outside air door 20 is moved between the outside air blocking position and the inside air blocking position. This makes it possible to set the position at which the inside-outside air door 20 is stopped more finely.

Further, in the first transmission groove portion 334 according to the present embodiment, the groove length Lg1 in which the drive pin 321 slides is longer than the groove length Lg2 in which the drive pin 321 slides in the second transmission groove portion 335. According to the above configuration, the amount of movement of the inside-outside air door 20 relative to the rotation angle of the output shaft 411 when the drive pin 321 moves in the first transmission groove portion 334 is further reduced as compared with the case where the drive pin 321 moves in the second transmission groove portion 335. In other words, the amount of movement of the inside-outside air door 20 per unit rotation angle of the output shaft 411 when the drive pin 321 moves in the first transmission groove portion 334 becomes further smaller than the amount of movement when the drive pin 321 moves in the second transmission groove portion 335. For that reason, if the drive pin 321 is configured to move in the first transmission groove portion 334 having a longer groove length than the second transmission groove portion 335 as in the present embodiment, the position at which the inside-outside air door 20 is stopped can be set more finely.

Although representative embodiments of the present disclosure have been described above, the present disclosure is not limited to the embodiments described above, and various modifications can be made, for example, as follows.

In the embodiments described above, the link mechanism 30 that moves the inside-outside air door 20 from the inside air blocking position to the outside air blocking position when the output shaft 411 is rotated by 180° in the forward direction from the predetermined reference angle has been exemplified, but the present embodiment is not limited to the above configuration. As the link mechanism 30, it is also possible to employ a mechanism in which the inside-outside air door 20 is moved from the outside air blocking position to the inside air blocking position when the output shaft 411 is rotated by 180° in the forward direction from the predetermined reference angle.

In the embodiments described above, an example in which the link mechanism 30 is configured by three elements, that is, the door side lever 31, the motor side lever 32, and the intermediate link member 33, has been described, but the present embodiment is not limited to the above configuration. The link mechanism 30 may be configured by, for example, four or more elements.

In the embodiments described above, the output shaft 411 is rotated so that the drive pin 321 moves in the first transmission groove portion 334 away from the intermediate support shaft 331 when moving the inside-outside air door 20 between the outside air blocking position and the inside air blocking position, but the present disclosure is not limited to the above configuration. The inside/outside air switching device 1 may be configured to rotate the output shaft 411 so that the drive pin 321 moves in the second transmission groove portion 335 close to the intermediate support shaft 331 when the inside-outside air door 20 is moved between the outside air blocking position and the inside air blocking position.

In the embodiments described above, the configuration has been exemplified in which the groove length of the first transmission groove portion 334 is longer than the groove length of the second transmission groove portion 335, but the present disclosure is not limited to the above configuration, and the groove length of the first transmission groove portion 334 may be equal to the groove length of the second transmission groove portion 335.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, it is not limited to the shape, positional relationship, and the like, except for the case where it is specifically specified, the case where it is fundamentally limited to a specific shape, positional relationship, and the like, and the like.

In conclusion, according to a first aspect described in part or all of the embodiments described above, the actuator of the inside/outside air switching device is provided with a potentiometer for detecting the rotation angle of the output shaft. The actuator is configured to rotate the output shaft in the operation range between the reference angle and the rotation angle rotated by 180° in the forward direction from the reference angle in accordance with the detection value of the potentiometer when moving the inside-outside air door between one position and the other position.

According to a second aspect, the link mechanism of the inside/outside air switching device includes the motor side lever having a drive pin and rotating together with the output shaft. The link mechanism also includes the intermediate link member having the intermediate pin and the intermediate guide groove in which the drive pin slides and pivots about the intermediate support shaft as the drive pin moves by pivoting of the motor side lever. Further, the link mechanism includes the door side lever that is coupled to the inside-outside air door, has the driven side guide groove in which the intermediate pin slides, and is rotated about the driven side support shaft in accordance with the movement of the intermediate pin by the rotation of the intermediate link member.

The intermediate guide groove has the first transmission groove portion that transmits the movement of the drive pin to the door side lever when the output shaft rotates by 180° in the forward direction from the reference angle, and moves the inside-outside air door from one position to the other position. Further, the intermediate guide groove includes the second transmission groove portion for transmitting the movement of the drive pin to the door side lever and moving the inside-outside air door from the other position to one position when the output shaft is further rotated by 180° in the forward direction from the rotation angle rotated by 180° in the forward direction with respect to the reference angle.

The first transmission groove portion is formed at a position farther from the intermediate support shaft than the second transmission groove portion in the intermediate link member. The actuator is configured to rotate the output shaft so that the drive pin moves in the first transmission groove portion when moving the inside-outside air door between the outside air blocking position and the inside air blocking position.

When the drive pin moves in the first transmission groove portion away from the intermediate support shaft, the amount of movement of the inside-outside air door with respect to the rotation angle of the output shaft is smaller than the amount of movement when the drive pin moves in the second transmission groove portion close to the intermediate support shaft.

For that reason, if the drive pin is configured to move in the first transmission groove portion away from the intermediate support shaft when moving the inside-outside air door between the outside air blocking position and the inside air blocking position, the position at which the inside-outside air door is stopped can be set more finely.

According to a third aspect, in the first transmission groove portion of the inside/outside air switching device, the groove length in which the drive pin slides is longer than the groove length in which the drive pin slides in the second transmission groove portion. In this manner, if the groove length in which the drive pin slides in the first transmission groove portion is set to be longer than the groove length in which the drive pin slides in the second transmission groove portion, the amount of movement of the inside-outside air door with respect to the rotation angle of the output shaft when the drive pin moves in the first transmission groove portion becomes even smaller. For that reason, if the drive pin is configured to move in the first transmission groove portion having a longer groove length than the length of the second transmission groove portion, the position at which the inside-outside air doors are stopped can be se more finely.

The inside/outside air switching device 1 illustrated above includes an inside-outside air case 10 that includes an inside air introduction port 12 for introducing inside air and an outside air introduction port 11 for introducing outside air, an inside-outside air door 20 configured to open or close the inside air introduction port 12 and the outside air introduction port 11, an actuator 40 that includes a servomotor 41 having an output shaft 411 configured to output driving force for rotationally driving the inside-outside air door 20, and a link mechanism 30 configured to transmit the driving force outputted by the output shaft 411 to the inside-outside air door 20.

When the output shaft 411 rotates by 180 degrees from a predetermined reference angle in a forward direction, the link mechanism 30 is configured to move the inside-outside air door 20 from one position of an outside air blocking position to close the outside air introduction port 11 and an inside air blocking position to close the inside air introduction port 12 to the other one position of the outside air blocking position and the inside air blocking position. When the output shaft 411 further rotates by 180 degrees in the forward direction from a rotation angle of the output shaft 411, which has rotated by 180 degrees from the reference angle in the forward direction, the link mechanism 30 is configured to move the inside-outside air door 20 from the other one position to the one position.

The actuator 40 includes a potentiometer 42 configured to detect a rotation angle of the output shaft 411. When moving the inside-outside air door 20 between the one position and the other one position, the actuator 40 is configured to rotate the output shaft 411 in an operation range between the reference angle and the rotation angle of the output shaft 411 rotated by 180 degrees from the reference angle in the forward direction in accordance with a detection value of the potentiometer 42.

In this manner, if the output shaft 411 is rotated in an operation range between the reference angle and the rotation angle rotated by 180° in the forward direction from the reference angle in accordance with a detection value of a potentiometer 42, the inside-outside air door 20 can be moved to the position where both of the inside air introduction port 12 and the outside air introduction port 11 are opened. This makes it possible to realize an inside/outside air switching device 1 capable of introducing both of the outside air and the inside air without changing the link mechanism 30.

What is claimed is:

1. An inside/outside air switching device for adjusting introduction amounts of inside air and outside air, comprising:
an inside-outside air case that includes an inside air introduction port through which to introduce inside air and an outside air introduction port though which to introduce outside air;
an inside-outside air door configured to open or close the inside air introduction port and the outside air introduction port;
an actuator that includes a servomotor having an output shaft configured to output driving force for rotationally driving the inside-outside air door; and
a link mechanism configured to transmit the driving force outputted by the output shaft to the inside-outside air door, wherein:
when the output shaft rotates by 180 degrees from a predetermined reference angle in a forward direction, the link mechanism is configured to move the inside-outside air door from one position of an outside air blocking position to close the outside air introduction port and an inside air blocking position to close the inside air introduction port to the other one position of the outside air blocking position and the inside air blocking position;
when the output shaft further rotates by 180 degrees in the forward direction from a rotation angle of the output shaft, which has rotated by 180 degrees from the reference angle in the forward direction, the link mechanism is configured to move the inside-outside air door from the other one position to the one position;
the servomotor is configured to rotate the output shaft not only in the forward direction but also in a backward direction, which is opposite from the forward direction;
the actuator includes a potentiometer configured to detect a rotation angle of the output shaft; and
the actuator is configured to rotate the output shaft by the servomotor in the forward direction or the backward direction in an operation range between the reference angle and the rotation angle of the output shaft rotated by 180 degrees from the reference angle in the forward direction in accordance with a detection value of the potentiometer, to move the inside-outside air door between the one position and the other one position.
